(19) United States
(12) Patent Application Publication
(10) Pub. No.: US 2023/0037532 A1
(43) Pub. Date: Feb. 9, 2023

(54) INFORMATION PROCESSING APPARATUS, INFORMATION PROCESSING METHOD AND NON-TRANSITORY STORAGE MEDIUM

(71) Applicant: TOYOTA JIDOSHA KABUSHIKI KAISHA, Toyota-shi (JP)

(72) Inventors: Kotaro OKABE, Ichikawa-shi (JP); Mayuko ABE, Shinagawa-ku (JP); Satoshi KOMAMINE, Nagoya-shi (JP); Takeaki DOHDA, Nagoya-shi (JP); Ken MATSUSHITA, Nagoya-shi (JP); Yosuke TAKADA, Nagoya-shi (JP)

(21) Appl. No.: 17/812,513

(22) Filed: Jul. 14, 2022

(30) Foreign Application Priority Data
Aug. 6, 2021 (JP) 2021-129751

(51) Int. Cl. G06Q 10/08

(52) U.S. Cl. CPC G06Q 10/0834; G06Q 10/0838

(57) ABSTRACT

The present disclosure provides a technology capable of favorably using a vehicle driven by a driver or an autonomous vehicle as a delivery vehicle to deliver goods. An information processing apparatus includes a controller including at least one processor configured to execute assigning either a first vehicle that is a vehicle driven by a driver or a second vehicle that is an autonomous vehicle as a delivery vehicle to deliver goods to a user. When a predetermined event other than the delivery of the goods to the user is requested to be performed at a delivery destination, the controller selects the first vehicle as the delivery vehicle.

### CROSS REFERENCE TO THE RELATED APPLICATION

This application claims the benefit of Japanese Patent Application No. 2021-129751, filed on Aug. 6, 2021, which is hereby incorporated by reference herein in its entirety.

### BACKGROUND

### Technical Field

The present disclosure relates to a technology for managing delivery of goods by a vehicle.

### Description of the Related Art

International Publication No. WO 2018/229871 discloses a delivery system for delivering an article using a mobile body. In the delivery system disclosed in International Publication No. WO 2018/229871, a first mobile body is specified as a delivery destination of an article. Furthermore, identification information or movement plan information about the first mobile body is provided for a second mobile body. Then, the second mobile body autonomously moves aiming for the first mobile body.
[Patent document 1] International Publication No. WO 2018/229871.

### SUMMARY

One or more aspects of the present disclosure are directed to provide a technology capable of favorably using a vehicle driven by a driver or an autonomous vehicle as a delivery vehicle to deliver goods.

An information processing apparatus according to a first aspect of the present disclosure may include a controller comprising at least one processor configured to execute assigning either a first vehicle that is a vehicle driven by a driver or a second vehicle that is an autonomous vehicle as a delivery vehicle to deliver goods to a user; and when a predetermined event other than the delivery of the goods to the user is requested to be performed at a delivery destination, the controller selects the first vehicle as the delivery vehicle.

An information processing method according to a second aspect of the present disclosure may be an information processing method executed by a computer, the information processing method comprising assigning either a first vehicle that is a vehicle driven by a driver or a second vehicle that is an autonomous vehicle as a delivery vehicle to deliver goods to a user, wherein, when a predetermined event other than the delivery of the goods to the user is requested to be performed at a delivery destination, the first vehicle is selected as the delivery vehicle.

A computer-readable storage medium non-transitorily storing a program according to a third aspect of the present disclosure may be a computer-readable storage medium non-transitorily storing a program for causing a terminal associated with a user who receives goods to execute a first information processing method, wherein the first information processing method comprises transmitting user information from the terminal to a predetermined server; the predetermined server is an apparatus that executes assigning a first vehicle that is a vehicle driven by a driver or a second vehicle that is an autonomous vehicle, as a delivery vehicle to deliver the goods to the user based on the user information; and the user information includes information indicating whether or not the user requests a predetermined event other than the delivery of the goods to the user to be performed.

According to the present disclosure, it is possible is to favorably use a vehicle driven by a driver or an autonomous vehicle as a delivery vehicle to deliver goods.

### BRIEF DESCRIPTION OF THE DRAWINGS

FIG. 1 is a diagram illustrating a schematic configuration of a delivery management system;

FIG. 2 is a block diagram schematically illustrating an example of a functional configuration of each of a user terminal and a management server;

FIG. 3 is a diagram illustrating an example of an operation screen displayed on a touch panel display of an input/output unit of the user terminal;

FIG. 4 is a diagram illustrating an example of a table configuration of user information;

FIG. 5 is a flowchart illustrating a flow of information processing executed by a controller of the user terminal;

FIG. 6 is a flowchart illustrating a flow of information processing executed by a controller of the management server;

FIG. 7 is a block diagram schematically illustrating an example of a functional configuration of the management server according to a modification of an embodiment; and

FIG. 8 is a flowchart illustrating a flow of information processing executed by the controller of the management server according to the modification of the embodiment.

### DESCRIPTION OF THE EMBODIMENTS

An information processing apparatus according to a first aspect of the present disclosure may be provided with a controller including at least one processor that executes assignment of a delivery vehicle to deliver goods to a user. Here, the vehicle assigned as the delivery vehicle may be a first vehicle that is a vehicle driven by a driver or a second vehicle that is an autonomous vehicle.

It is possible to hand over the goods to the user no matter which of the first vehicle and the second vehicle is the delivery vehicle. However, it may be requested to perform a predetermined event other than handing over the goods to the user at the time of delivering the goods to a delivery destination. The predetermined event is, for example, placement of the goods or collection of an article other than the goods. At this time, when the goods are delivered by the second vehicle, which is an autonomous vehicle, it may be difficult to perform the predetermined event at the delivery destination because a driver is not in the second vehicle.

Therefore, when the predetermined event is requested to be performed at the delivery destination, the controller may select the first vehicle as the delivery vehicle. Thereby, not the second vehicle but the first vehicle may be assigned as the delivery vehicle to deliver the goods to the user. A driver may be in the first vehicle. Therefore, by delivering the goods by the first vehicle, it becomes possible to perform the predetermined event by the driver of the first vehicle at the delivery destination.

A specific embodiment of the present disclosure will be described below based on drawings. As for components described in the present embodiment, sizes, materials, shapes, relative arrangement and the like are not intended to limit the technological range of the present disclosure thereto unless otherwise stated.

### Embodiment

### (Outline of System)

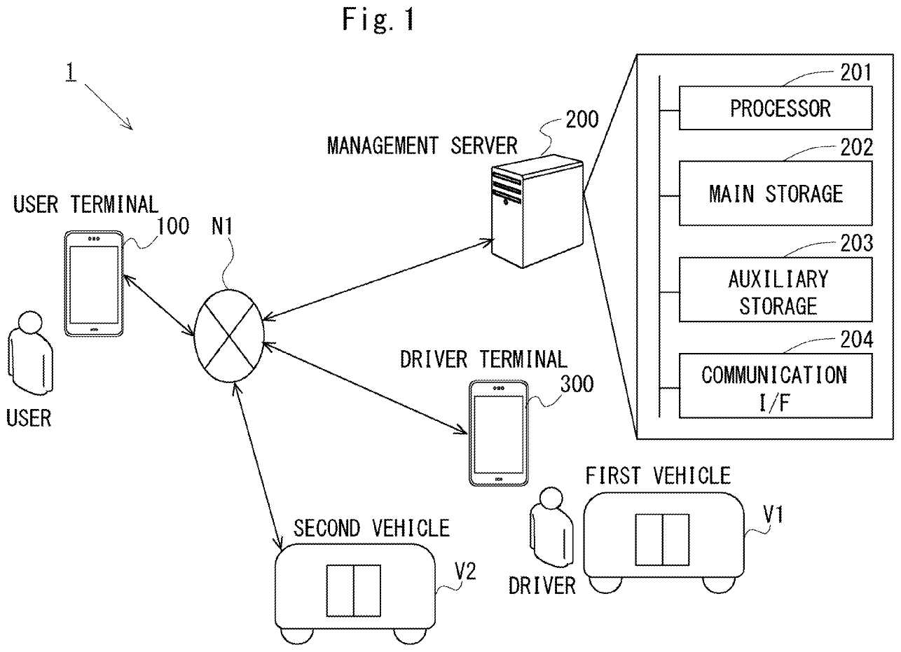

FIG. 1 is a diagram illustrating a schematic configuration of a delivery management system according to the present embodiment. A delivery management system 1 is a system for delivering a product purchased by a user by a vehicle. Here, as a delivery vehicle used to deliver the product purchased by the user as goods, two types of vehicles, a first vehicle V1 and a second vehicle V2 exist. The first vehicle V1 is a vehicle driven by a driver. The second vehicle V2 is an autonomous vehicle. The second vehicle V2 can autonomously travel based on a delivery plan transmitted from a management server 200. Therefore, when goods are delivered by the second vehicle V2, a person is not in the second vehicle V2. That is, the second vehicle V2 travels in an unmanned state.

As illustrated in FIG. 1, the delivery management system 1 is configured including a user terminal 100, the management server 200, a driver terminal 300 and the second vehicle V2. In the delivery management system 1, the user terminal 100, the management server 200, the driver terminal 300 and the second vehicle V2 are mutually connected via a network N1. As the network N1, for example, a WAN (wide area network) which is a global public communication network, such as the Internet, or a telephone communication network for a mobile phone or the like may be adopted.

The management server 200 is a server for managing the first vehicle V1 and the second vehicle V2 to be delivery vehicles. A computer constituting the management server 200 includes a processor 201, a main storage 202, an auxiliary storage 203 and a communication interface (communication I/F) 204.

Here, the processor 201 is, for example, a CPU (central processing unit) or a DSP (digital signal processor). The main storage 202 is, for example, a RAM (random access memory). The auxiliary storage 203 is, for example, a ROM (read-only memory), an HDD (hard disk drive) or a flash memory. As the auxiliary storage 203, a removable medium (a removable recording medium) may be included. Here, the removable medium is, for example, a USB memory, an SD card or a disk recording medium like a CD-ROM, a DVD disk or a Blu-ray disc. The communication I/F 204 is, for example, a LAN (local area network) interface board or a wireless communication circuit for wireless communication.

In the auxiliary storage 203, an operating system (OS), various types of programs, various types of information tables and the like are stored. By the processor 201 loading a program stored in the auxiliary storage 203 onto the main storage 202 and executing the program, various controls for delivering goods to a user as described later are realized. However, a part or all of functions of the management server 200 may be realized by a hardware circuit like an ASIC or an FPGA. The management server 200 is not necessarily required to be realized by a single physical configuration but may be configured with a plurality of mutually cooperating computers. In the present embodiment, the management server 200 corresponds to “an information processing apparatus” according to the present disclosure.

The user terminal 100 is a terminal associated with a user. As the user terminal 100, a personal computer, a smartphone, a tablet computer or a wearable terminal can be exemplified. The user can access a website or the like using the user terminal 100 to purchase a product. Then, the user terminal 100 transmits user information including information about the product purchased by the user to the management server 200 via the network N1. By the user information being transmitted from the user terminal 100 to the management server 200, the user can request delivery of the purchased product. Note that the management server 200 receives user information from user terminals of a plurality of users. That is, the management server 200 can accept delivery requests of products from a plurality of users.

The management server 200 generates a delivery plan of the product based on the user information received from the user terminal 100. At this time, the management server 200 decides which of the first vehicle V1 and the second vehicle V2 is to be assigned as a delivery vehicle to deliver the product to the user. Details of a method for generating the delivery plan by the management server 200 will be described later.

When selecting the first vehicle V1 as the delivery vehicle, the management server 200 generates a delivery plan using the first vehicle V1. Furthermore, the management server 200 transmits the generated delivery plan to the driver terminal 300. The driver terminal 300 is a terminal associated with the driver of the first vehicle V1. The driver terminal 300 may be a terminal carried by the driver or may be a terminal installed in the first vehicle V1. By the delivery plan being transmitted from the management server 200 to the driver terminal 300, it becomes possible for the driver to drive the first vehicle V1 based on the delivery plan to deliver the product.

When selecting the second vehicle V2 as the delivery vehicle, the management server 200 generates a delivery plan using the second vehicle V2. Furthermore, the management server 200 transmits the generated delivery plan to the second vehicle V2. By the delivery plan being transmitted from the management server 200 to the second vehicle V2, it becomes possible for the second vehicle V2 to autonomously travel based on the delivery plan to deliver the product.

(Functional Configuration)

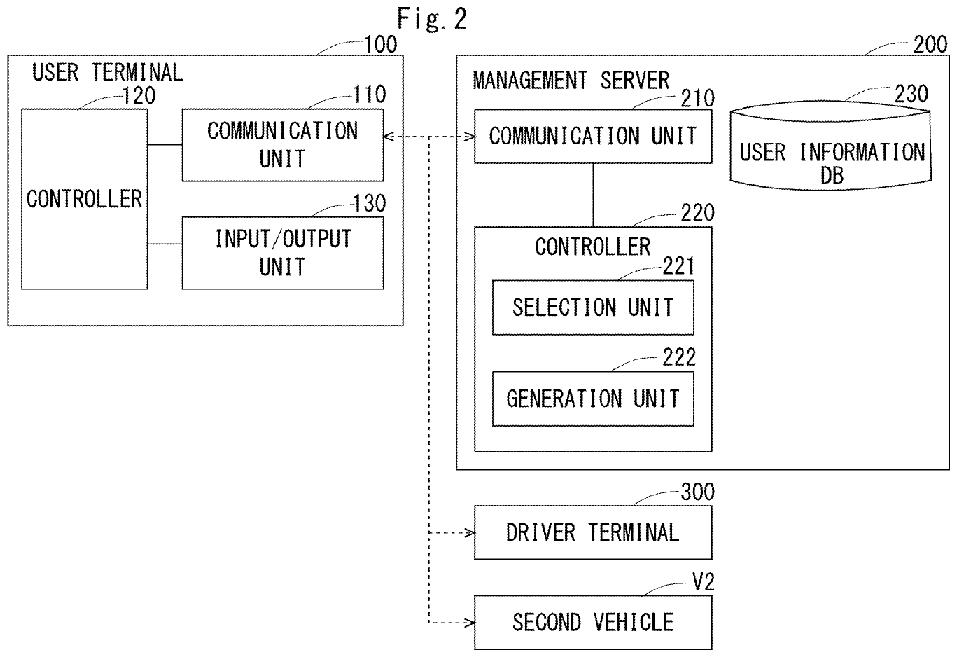

Next, a functional configuration of each of the user terminal 100 and the management server 200 constituting the delivery management system 1 will be described based on FIG. 2. FIG. 2 is a block diagram schematically illustrating an example of the functional configuration of each of the user terminal 100 and the management server 200.

(User Terminal)

The user terminal 100 includes a communication unit 110, a controller 120 and an input/output unit 130 as functional units. The communication unit 110 includes a function of connecting the user terminal 100 to the network N1. The communication unit 110 can be realized by a communication interface provided for the user terminal 100. The communication unit 110 can perform communication with other apparatuses including the management server 200 via the network N1 using a mobile communication service, for example, 3G (3rd Generation) or LTE (Long Term Evolution).

The controller 120 includes a function of performing arithmetic processing for controlling the user terminal 100. The controller 120 can be realized by a processor provided for the user terminal 100.

The input/output unit 130 includes a function of accepting an input operation performed by a user and a function of outputting information to be presented to the user. For example, the input/output unit 130 is configured including a touch panel display. The user can input information about a product he purchases to the user terminal 100 via the input/output unit 130. Further, the user can input information about a product delivery destination and delivery date and time that the user desires, to the user terminal 100 via the input/output unit 130. Furthermore, the user can input a requested item other than the delivery of the product, to the user terminal 100 via the input/output unit 130.

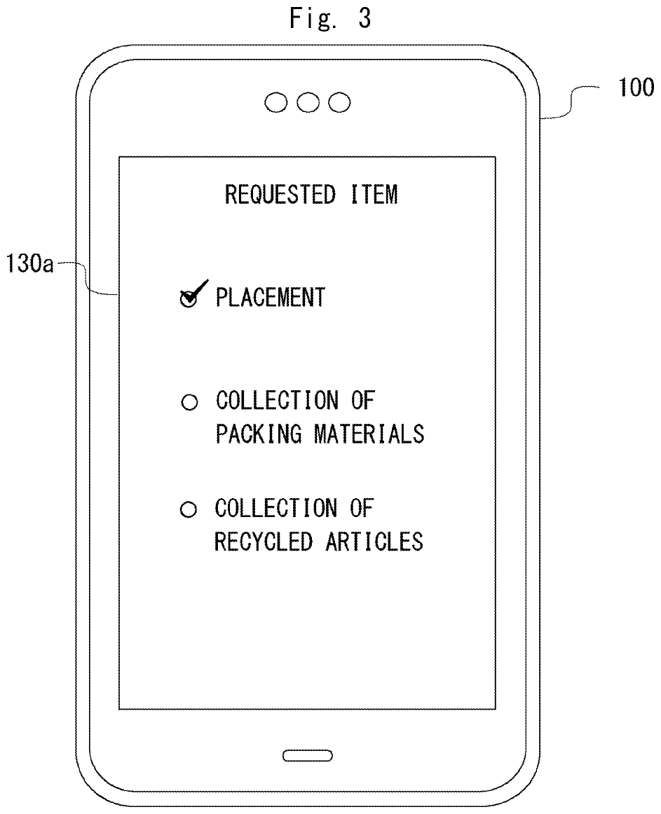

FIG. 3 is a diagram illustrating an example of an operation screen displayed on a touch panel display 130a of the input/output unit 130 of the user terminal 100. The user can input the requested item on the operation screen illustrated in FIG. 3. The requested item is an item that is requested by the user to be performed at the delivery destination when the product is delivered. As illustrated in FIG. 3, “placement”, “collection of packing materials” and “collection of recycled articles” can be exemplified as the requested item. Placement is to place the product at a specified place at the delivery destination without handing over the product to the user face to face. Collection of packing materials is to collect packing materials of the delivered product. Collection of recycle articles is to collect recyclable articles the user possesses. The user selects a requested item that the user requests, on the operation screen illustrated in FIG. 3. Note that the requested items are not limited to the items illustrated in FIG. 3. Each requested item corresponds to “a predetermined event” according to the present disclosure.

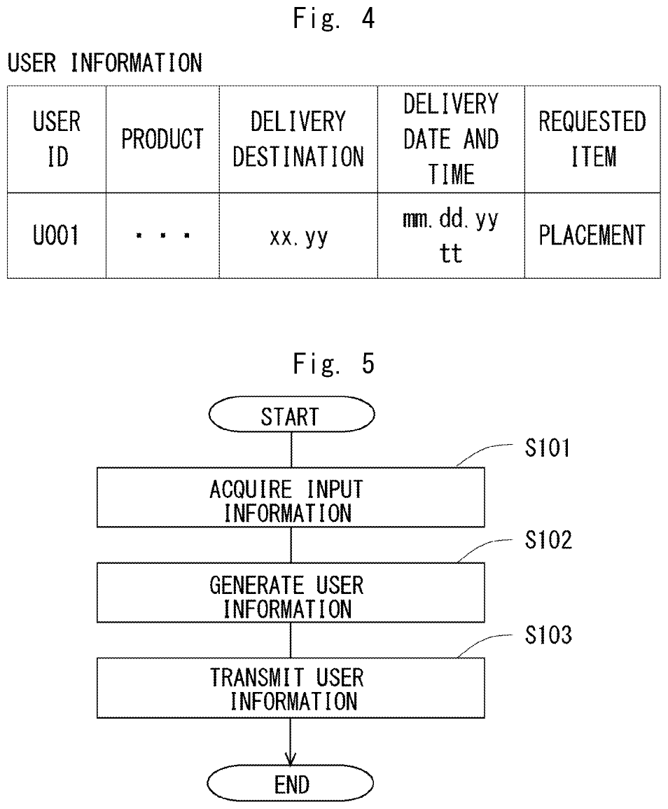

Then, the controller 120 generates user information based on the information inputted via the input/output unit 130. FIG. 4 is a diagram illustrating an example of a table configuration of the user information. As illustrated in FIG. 4, the user information includes a user ID field, a product field, a delivery destination field, a delivery date and time field and a requested item field. In the user ID field, a user ID that is identification information for identifying the user is inputted. In the product field, information about the product purchased by the user is inputted. In the delivery destination field and the delivery date and time field, pieces of information about the product delivery destination and delivery date and time desired by the user are inputted, respectively. In the requested item field, the requested item selected by the user on the operation screen illustrated in FIG. 3 is inputted. Note that, when the user does not desire that an item other than the delivery of the product is performed at the delivery destination, a requested item is not inputted by the user on the operation screen illustrated in FIG. 3. In this case, a requested item is not inputted in the requested item field of the user information. Then, the controller 120 performs a process of transmitting the generated user information to the management server 200 using the communication unit 110.

(Management Server)

The management server 200 includes a communication unit 210, a controller 220 and a user information database (user information DB) 230 as functional units. The communication unit 210 includes a function of connecting the management server 200 to the network N1. The communication unit 210 can be realized by the communication I/F 204. The controller 220 includes a function of performing arithmetic processing for controlling the management server 200. The controller 220 can be realized by the processor 201. The controller 220 performs a process of receiving the user information transmitted from the user terminal 100 using the communication unit 210. Furthermore, the controller 220 performs a process of storing the user information received from the user terminal 100 into the user information DB 230. In the user information DB 230, user information received from each user terminal is stored.

Further, the controller 220 includes a selection unit 221 and a generation unit 222. The controller 220 acquires user information about one user stored in the user information DB 230 at the time of generating a delivery plan. Then, the selection unit 221 selects either the first vehicle V1 or the second vehicle V2 as a delivery vehicle to deliver a product to the one user based on the acquired user information. Specifically, the selection unit 221 selects a delivery vehicle based on whether or not a requested item is inputted in the requested item field of the user information.

Here, as described above, when the product is delivered by the second vehicle V2, which is an autonomous vehicle, a person is not in the second vehicle V2. Therefore, it is difficult to perform something other than the delivery of the product to the user at a delivery destination when the second vehicle V2 is used. Therefore, when the product is delivered to the one user by the second vehicle V2 in a case where, as described above, the one user requests a requested item other than the delivery of the product to be performed at the delivery destination at the time of the product being delivered, it is difficult to perform the requested item.

Therefore, when some requested item is inputted in the requested item field of the user information about the one user, the selection unit 221 selects the first vehicle V1 as the delivery vehicle to deliver the product to the one user. As described above, a driver is in the first vehicle V1. Therefore, by delivering the product to the one user by the first vehicle V1, it becomes possible to perform the requested item by the driver of the first vehicle V1 at the delivery destination. Further, when no requested item is inputted in the requested item field of the user information about the one user, the selection unit 221 selects the second vehicle V2 as the delivery vehicle to deliver the product to the one user.

Then, the generation unit 222 generates a delivery plan that includes the delivery of the product to the one user. At this time, the delivery plan is generated with the vehicle selected by the selection unit 221 as the delivery vehicle. Further, the controller 220 performs a process of transmitting the delivery plan generated by the generation unit 222 to the driver terminal 300 or the second vehicle V2 using the communication unit 210.

(Flow of Information Processing in User Terminal)

A flow of information processing executed in the user terminal 100 constituting the delivery management system 1 will be described below based on FIG. 5. FIG. 5 is a flowchart illustrating the flow of the information processing executed by the controller 120 of the user terminal 100.

In this flow, first, at S101, information inputted to the input/output unit 130 by the user at the time of the user purchasing a product using the user terminal 100 is (input information) acquired. As described above, the input information includes information about the product purchased by the user and information about a product delivery destination and delivery date and time desired by the user. Further, when some requested item is selected by the user, the requested item is also included in the input information.

Next, at S102, user information as exemplified in FIG. 4 is generated based on the input information acquired at S101. The user information generated then includes information whether there is a requested item or not, that is, information indicating whether or not the user requests a requested item other than delivery of goods to the user to be performed at the delivery destination. Next, at S103, the user information generated at S102 is transmitted to the management server 200.

(Flow of Information Processing in Management Server)

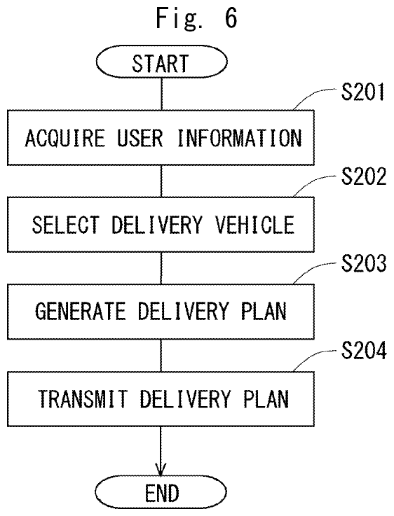

Next, a flow of information processing executed in the management server 200 constituting the delivery management system 1 will be described based on FIG. 6. FIG. 6 is a flowchart illustrating the flow of the information processing executed by the controller 220 of the management server 200.

In this flow, first, at S201, user information about one user stored in the user information DB 230 is acquired. Next, at S202, a delivery vehicle to deliver a product to the one user is selected. At this time, when a requested item is inputted in the requested item field of the user information acquired at S201, the controller 220 judges that the requested item is requested to be performed at a delivery destination. Then, the controller 220 selects the first vehicle V1 as the delivery vehicle to deliver the product to the one user. On the other hand, when a requested item is not inputted in the requested item field of the user information acquired at S201, the controller 220 judges that a requested item is not requested to be performed at the delivery destination. Then, the controller 220 selects the second vehicle V2 as the delivery vehicle to deliver the product to the one user.

Next, at S203, a delivery plan that includes the delivery of the product to the one user is generated. At this time, when the first vehicle V1 has been selected as the delivery vehicle at S202, a delivery plan with the first vehicle V1 is generated. When the second vehicle V2 has been selected as the delivery vehicle at S202, a delivery plan with the second vehicle V2 is generated.

Next, at S204, the delivery plan generated at S203 is transmitted to the driver terminal 300 or the second vehicle V2. At this time, the delivery plan with the first vehicle V1 is transmitted to the driver terminal 300. On the other hand, the delivery plan with the second vehicle V2 is transmitted to the second vehicle V2.

The delivery plan may include delivery of products to a plurality of users. In this case, when there is a plurality of such users that a requested item is inputted in the requested item field of the user information, the first vehicle V1 is assigned as a delivery vehicle to these users. When there is a plurality of such users that a requested item is not inputted in the requested item field of the user information, the second vehicle V2 is assigned as a delivery vehicle to these users.

According to the delivery management system 1 according to the present embodiment, the first vehicle V1 is assigned as a delivery vehicle to a user who requests a requested item to be performed at a delivery destination. That is, when it is necessary for a person (a driver) to perform a requested item other than delivery of a product to a user at a delivery destination, the product is delivered by the first vehicle V1. On the other hand, for a user who does not request a requested item to be performed at a delivery destination, the second vehicle V2 is assigned as a delivery vehicle. That is, when it is necessary only to hand over a product to a user at a delivery destination, the product is delivered by the second vehicle V2. Therefore, it is possible to more favorably use the first vehicle V1 driven by a driver or the second vehicle V2, which is an autonomous vehicle, as a delivery vehicle.

In the delivery management system 1, the management server 200 may transmit notification information to the user terminal 100 of a user who is a delivery destination when generating a delivery plan. At this time, when selecting the first vehicle V1 as a delivery vehicle, the management server 200 notifies the user that a product is delivered by a vehicle driven by a driver, by the notification information. When selecting the second vehicle V2 as the delivery vehicle, the management server 200 notifies the user that the product is delivered by an autonomous vehicle, by the notification information. By transmitting such notification information to the user terminal 100, it becomes possible for the user to request the management server 200 to change the delivery vehicle when he desires to change the delivery vehicle.

(Modification)

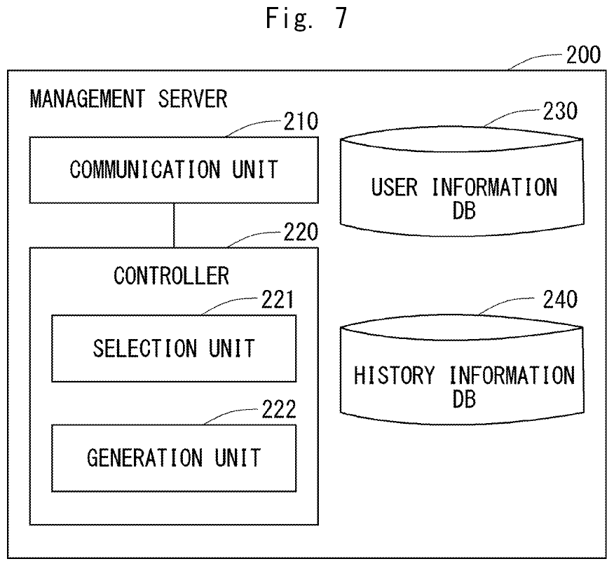

Next, a modification of the present embodiment will be described. FIG. 7 is a block diagram schematically illustrating an example of a functional configuration of the management server 200 according to the present modification. In the present modification, the management server 200 also receives user information from the user terminal 100. In the present modification, however, the user information does not include the information about whether there is a requested item or not according to the above embodiment. That is, the user information according to the present modification does not include the requested item field that the user information illustrated in FIG. 4 includes.

In the present modification, however, the management server 200 includes a history information database (history information DB) 240 in addition to the user information DB 230 as illustrated in FIG. 7. The history information DB 240 stores information about a past delivery history for each user. The information about the delivery history stored in the history information DB 240 includes information about products delivered to the user in the past and delivery destinations and delivery dates and time of the products. Further, the information about the delivery history stored in the history information DB 240 includes information indicating whether or not a predetermined event corresponding to a requested item according to the above embodiment was performed at the delivery destination at the time of delivering each product to the user in the past.

Therefore, in the present modification, the controller 220 selects either the first vehicle V1 or the second vehicle V2 as a delivery vehicle to deliver a product to a user based on the information about the delivery history stored in the history information DB 240.

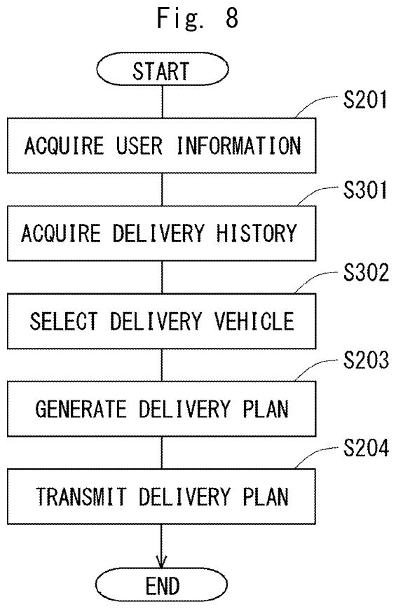

Here, a flow of information processing executed in the management server 200 according to the present modification will be described based on FIG. 8. FIG. 8 is a flowchart illustrating the flow of the information processing executed by the controller 220 of the management server 200 according to the present modification. Processes executed at steps S201, S203 and S204 of this flow are the same as the processes executed at the steps with the same reference signs in the flow illustrated in FIG. 6. Therefore, description of the steps will be omitted.

In this flow, a process of S301 is executed after the process of S201. At S301, information about a delivery history about one user stored in the history information DB 240 is acquired. Next, at S302, a delivery vehicle to deliver a product to the one user is selected based on the information about the delivery history acquired at S301.

At this time, the controller 220 judges whether or not a predetermined event at a delivery destination at the time of delivering the product to the one user is requested to be performed this time, based on the information about the delivery history. For example, when there is a record of performing placement at the time of delivering a product to the one user in the past, there is a strong possibility that the one user also desires placement to be performed at the time of delivering the product this time as well. When there is a record of performing collection of packing materials or collection of recyclable articles at the time of delivering a product to the one user in the past, there is a strong possibility that the one user also desires collection of a similar article to be performed at the time of delivering the product this time.

Therefore, when the information about the delivery history for the one user includes information indicating that a predetermined event was performed at a delivery destination in the past, the controller 220 judges that the predetermined event is also requested by the one user to be performed at the delivery destination at the time of delivering the product this time. Then, the controller 220 selects the first vehicle V1 as the delivery vehicle to deliver the article to the one user. On the other hand, when the information about the delivery history about the one user does not include the information indicating that a predetermined event was performed at a delivery destination in the past, the controller 220 judges that the predetermined event is also not requested by the one user to be performed at the delivery destination this time. Then, the controller 220 selects the second vehicle V2 as the delivery vehicle to deliver the article to the one user. After the process of S302, the process of S203 is executed.

According to the present modification, for a user who is likely to request a predetermined event to be performed at a delivery destination, the first vehicle V1 is assigned as a delivery vehicle. On the other hand, for a user who is likely not to request a predetermined event to be performed at a delivery destination, the second vehicle V2 is assigned as a delivery vehicle. Therefore, even in a case where user information transmitted from the user terminal 100 does not include information about whether there is a requested item or not, it is possible to more favorably use the first vehicle V1 or the second vehicle V2 as a delivery vehicle.

In the embodiment and modification described above, the goods delivered by a delivery vehicle are assumed to be a product purchased by a user. However, the goods delivered by a delivery vehicle in the present disclosure are not limited to a product purchased by a user.

### Other Embodiments

The embodiments described above are mere examples, and the present disclosure can be appropriately changed and practiced within a range not departing from the spirit of the disclosure. Further, the processes and means described in the present disclosure can be freely combined and implemented as far as a technical problem does not occur.

Further, a process described as being performed by one apparatus may be shared and executed by a plurality of apparatuses. Or alternatively, processes described as being performed by different apparatuses may be executed by one apparatus. In a computer system, by what hardware configuration (server configuration) each function is realized can be flexibly changed.

The present disclosure can be realized by supplying a computer program implemented with the functions described in the above embodiments to a computer, and one or more processors that the computer includes reading out and executing the program. Such a computer program may be provided for the computer by a non-transitory computer-readable storage medium that can be connected to the system bus of the computer or may be provided for the computer via a network. As the non-transitory computer-readable medium, for example, any type of disk such as a magnetic disk (a floppy (registered trademark) disk, a hard disk drive (HDD) or the like) and an optical disk (a CD-ROM, a DVD disk, a Blu-ray Disc or the like), and any type of medium suitable for storing electronic instructions like a read-only memory (ROM), a random access memory (RAM), an EPROM, an EEPROM, a magnetic card, a flash memory or an optical card are included.

What is claimed is:

1. An information processing apparatus comprising a controller comprising at least one processor configured to execute assigning either a first vehicle that is a vehicle driven by a driver or a second vehicle that is an autonomous vehicle as a delivery vehicle to deliver goods to a user, wherein
when a predetermined event other than the delivery of the goods to the user is requested to be performed at a delivery destination, the controller selects the first vehicle as the delivery vehicle.

2. The information processing apparatus according to claim 1, wherein, when the predetermined event is not requested to be performed at the delivery destination, the controller selects the second vehicle as the delivery vehicle.

3. The information processing apparatus according to claim 1, wherein the predetermined event is placement of the goods or collection of an article other than the goods.

4. The information processing apparatus according to claim 1, wherein, when receiving information indicating the request to perform the predetermined event from a terminal associated with the user, the controller judges that the predetermined event is requested to be performed at the delivery destination.

5. The information processing apparatus according to claim 1, wherein the controller further executes judging whether or not the predetermined event is requested to be performed at the delivery destination, based on information about a past delivery history for the user.

6. The information processing apparatus according to claim 1, wherein, when selecting the first vehicle as the delivery vehicle, the controller further executes transmitting a delivery plan that includes the delivery of the goods to the user, to a terminal associated with the driver of the first vehicle.

7. The information processing apparatus according to claim 2, wherein, when selecting the second vehicle as the delivery vehicle, the controller further executes transmitting a delivery plan that includes the delivery of the goods to the user, to the second vehicle.

8. The information processing apparatus according to claim 1, wherein, when selecting the first vehicle as the delivery vehicle, the controller further executes notifying the user that the goods are to be delivered by a vehicle driven by a driver.

9. The information processing apparatus according to claim 2, wherein, when selecting the second vehicle as the delivery vehicle, the controller further executes notifying the user that the goods are to be delivered by an autonomous vehicle.

10. An information processing method executed by a computer, the information processing method comprising assigning either a first vehicle that is a vehicle driven by a driver or a second vehicle that is an autonomous vehicle as a delivery vehicle to deliver goods to a user, wherein
when a predetermined event other than the delivery of the goods to the user is requested to be performed at a delivery destination, the first vehicle is selected as the delivery vehicle.

11. The information processing method according to claim 10, wherein, when the predetermined event is not requested to be performed at the delivery destination, the second vehicle is selected as the delivery vehicle.

12. The information processing method according to claim 10, wherein the predetermined event is placement of the goods or collection of an article other than the goods.

13. The information processing method according to claim 10, wherein, when receiving information indicating the request to perform the predetermined event from a terminal associated with the user, it is judged that the predetermined event is requested to be performed at the delivery destination.

14. The information processing method according to claim 10, further comprising judging whether or not the predetermined event is requested to be performed at the delivery destination, based on information about a past delivery history for the user.

15. The information processing method according to claim 10, further comprising transmitting a delivery plan that includes the delivery of the goods to the user, to a terminal associated with the driver of the first vehicle when the first vehicle is selected as the delivery vehicle.

16. The information processing method according to claim 11, further comprising transmitting a delivery plan that includes the delivery of the goods to the user, to the second vehicle when the second vehicle is selected as the delivery vehicle.

17. The information processing method according to claim 10, further comprising notifying the user that the goods are to be delivered by a vehicle driven by a driver when the first vehicle is selected as the delivery vehicle.

18. The information processing method according to claim 11, further comprising notifying the user that the goods are to be delivered by an autonomous vehicle when the second vehicle is selected as the delivery vehicle.

19. A non-transitory storage medium storing a program for causing a terminal associated with a user who receives goods to execute a first information processing method, wherein
the first information processing method comprises transmitting user information from the terminal to a predetermined server;
the predetermined server is an apparatus that executes assigning a first vehicle that is a vehicle driven by a driver or a second vehicle that is an autonomous vehicle, as a delivery vehicle to deliver the goods to the user based on the user information; and
the user information includes information indicating whether or not the user requests a predetermined event other than the delivery of the goods to the user to be performed at the delivery destination.

20. The non-transitory storage medium storing the program according to claim 19, wherein the predetermined event is placement of the goods or collection of an article other than the goods.
